(19) United States
(12) Patent Application Publication
(10) Pub. No.: US 2007/0069436 A1
(43) Pub. Date: Mar. 29, 2007

(54) Clamping table for workpieces in a machine tool

(76) Inventor: Wolfgang Zarske, Neustadt (DE)

Correspondence Address: BROMBERG & SUNSTEIN LLP, 125 SUMMER STREET, BOSTON, MA, 02110-1618, US

(21) Appl. No.: 10/577,771

(22) PCT Filed: Oct. 28, 2004
(86) PCT No.: PCT/EP04/12223

§ 371 Date: Jun. 30, 2006

(51) Int. Cl. B25B 3/00

(52) U.S. Cl. 269/1

(57) ABSTRACT

In a clamping table (1) for workpieces (8) in a machine tool, which includes a plurality of mutually juxtaposed clamping elements (3) which each have a respective telescopic tube unit (10) with a top-end suction plate (11), wherein the concentric tubes (13, 14) of the telescopic tube unit (10) are displaceable relative to each other by a positioning drive (12), the positioning drive (12) is arranged coaxially with respect to the telescopic tube unit (10) and either is releasably coupled to the displaceable telescopic tube (13) by means of a positively locking plug coupling (21, 25) or is permanently coupled to the displaceable telescopic tube (13) and is connected electrically to a power supply (53) by means of a releasable plug connection (50, 52).

The invention concerns a clamping table for workpieces in a machine tool, comprising a plurality of mutually juxtaposed clamping elements which each have a respective telescopic tube unit with a top-end suction plate, wherein the concentric tubes of the telescopic tube unit are displaceable relative to each other by a positioning drive.

German utility model No 201 07 746 discloses a so-called matrix table of that kind, which serves in particular for formatting panels of wood materials. Frequently such a clamping table is part of a machining centre and extending thereover is an extension arm which is displaceable in the longitudinal direction (x-direction) of the table and on which a tool head displaceable transversely (y-direction) and perpendicularly (z-direction) to the table is arranged and carries a drive spindle to which various machining assemblies such as more specifically milling and boring tools but also small circular saw blades can be coupled.

In the case of the clamping element known from German utility model No 201 07 746 a stepping motor is arranged at the upper end of the stationary telescopic tube and thus concentrically with respect thereto and the displaceable telescopic tube, with a spindle transmission which is fixed centrally thereto and which passes through the stepping motor, as the positioning drive. The electrical feed lines to the stepping motor pass through the stationary telescopic tube in parallel relationship with the spindle transmission while the displaceable telescopic tube engages over the stationary tube on the outside. Because only a relatively large diameter for the clamping elements can be embodied with that structure, that means that the table matrix is of a pitch division which is of correspondingly coarse graduation. Maintenance and repair operations are also impeded.

The invention in accordance with a first aspect counteracts those disadvantages of the state of the art in that the positioning drive is arranged coaxially with respect to the telescopic tube unit and is releasably coupled to the displaceable telescopic tube by means of a positively locking plug coupling. In that way it is possible for the clamping element to be of a more slender configuration, in which respect it is advantageous for the displaceable telescopic tube to be guided in the interior of the stationary outer telescopic tube. At the same time the entire clamping element—without the fixedly installed drive which is connected electrically or in some other fashion—can be replaced without any problem if problems in respect of mechanical guidance or leaks in regard to the suction air should occur.

In accordance with a second aspect of the invention the positioning drive is also arranged coaxially on the telescopic tube unit but is permanently coupled to the displaceable telescopic tube and is connected electrically to a power supply by means of a releasable plug connection. In this case therefore the positioning drive is part of the clamping element which is held releasably in the table so that admittedly there is no need for a mechanical coupling between the drive and the displaceable telescopic tube, but an electrical plug connection between the table and each clamping element is needed. That plug connection can at the same time form a mechanical centering means.

In both cases the positioning drive is preferably—as is known per se—a stepping motor and co-operates with a central spindle transmission in the telescopic tube unit. In that way different extension heights of the displaceable telescopic tube (and therewith the suction plate) can be implemented in very finely graduated fashion and in that way a plurality of different heightwise positions of the clamped workpiece can be achieved reproducibly and in a uniform fashion in respect of the clamping elements involved.

It is particularly advantageous for the telescopic units and the positioning drives to be arranged in transverse members which extend over the table, wherein fixingly plugging the clamping elements into the associated transverse members at the same time provides for mechanical and electrical coupling to the motor drive and the power supply thereof. Connection to the air supply means can also be implemented in a simple and elegant manner in that way.

In that respect a development of the clamping element provides that a suction air path extends from an access bore in the outer telescopic tube through the annular space between the tubes to an inlet bore in the inner telescopic tube, the internal space of which is in communication with the suction plate, wherein arranged in axial displacement towards the coupling in the inside wall of the outer telescopic tube is a seal in relation to the inner telescopic tube, which is between the inlet bore and the feed bore only in the completely retracted condition of the inner telescopic tube and a subsequent short extension region. With clamping elements of that kind, the clamping table according to the invention can be operated in such a way that the workpiece to be clamped is laid, with lateral alignment, on stationary supports which define a workpiece feed plane and which project beyond the completely retracted clamping elements, thereupon the clamping elements which are selected in a programmed mode are extended towards the workpiece and lift the workpiece to above the short extension region so that a reduced pressure passes through the suction air path to the suction plates forming the interrupted workpiece support surface and the workpiece is clamped fast, and finally those activated clamping elements are further extended into a working position—of a plurality of possible working positions—.

A further development of the clamping element which is not necessarily restricted to the above-described configuration thereof provides that an annular cuff is fixed in the stationary (outer) telescopic tube of the telescopic tube unit near the end remote from the coupling, wherein the space between the annular cuff and the inside wall of the stationary telescopic tube can be acted upon with compressed air in order clampingly to arrest the movable (inner) telescopic tube by pressing the cuff thereagainst. In particular the thin-wall cuff comprises plastic material integrally with spaced fixing and sealing rings. In that way, when the movable telescopic tubes of the clamping elements involved have reached an extended working position, those movable telescopic tubes can be braced in that position so that, upon subsequent machining of the clamped workpiece, the clamping elements are not caused to vibrate or oscillate by the forces which occur in that situation, which would adversely affect the degree of accuracy of the machining process.

Further configurations and details of the clamping table according to the invention and the clamping elements thereof are the subject-matter of further appendant claims: that also applies in regard to a method of calibrating the plane defined by the suction plates of the clamping elements.

Further details are shown by the views in the drawings of embodiments by way of example and the description hereinafter. In the drawings:

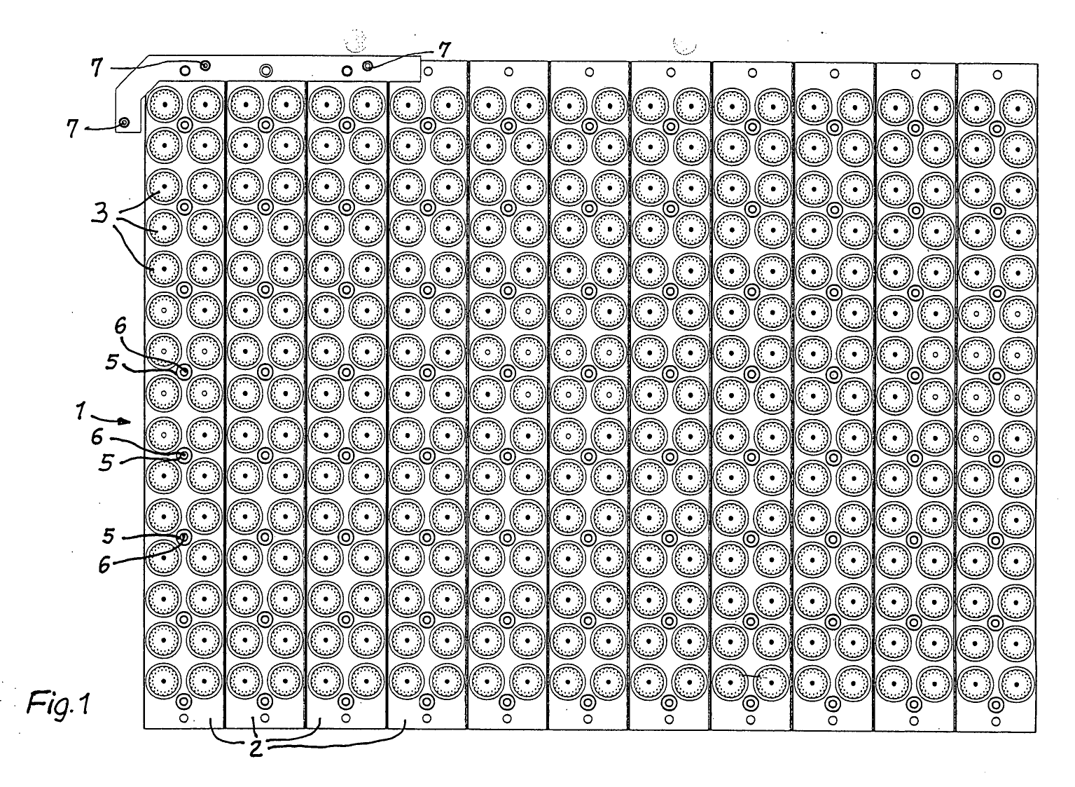

FIG. 1 shows a plan view of a clamping table according to the invention,

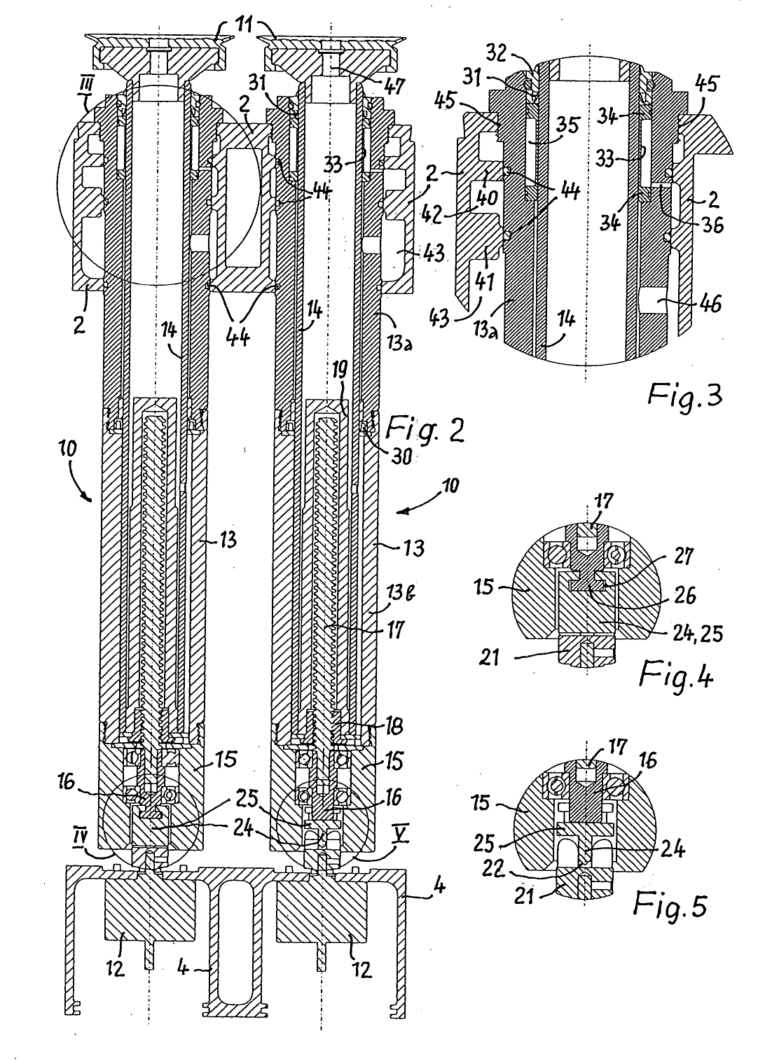

FIG. 2 shows a vertical section through two clamping elements which are adjacent in the x-direction and which belong to the same set of transverse members, in the rest position of the clamping elements,

FIG. 3 shows the circled portion III in FIG. 2 on an enlarged scale,

FIG. 4 shows the circled portion IV in FIG. 2 on an enlarged scale,

FIG. 5 shows the circled portion V in FIG. 2 on an enlarged scale,

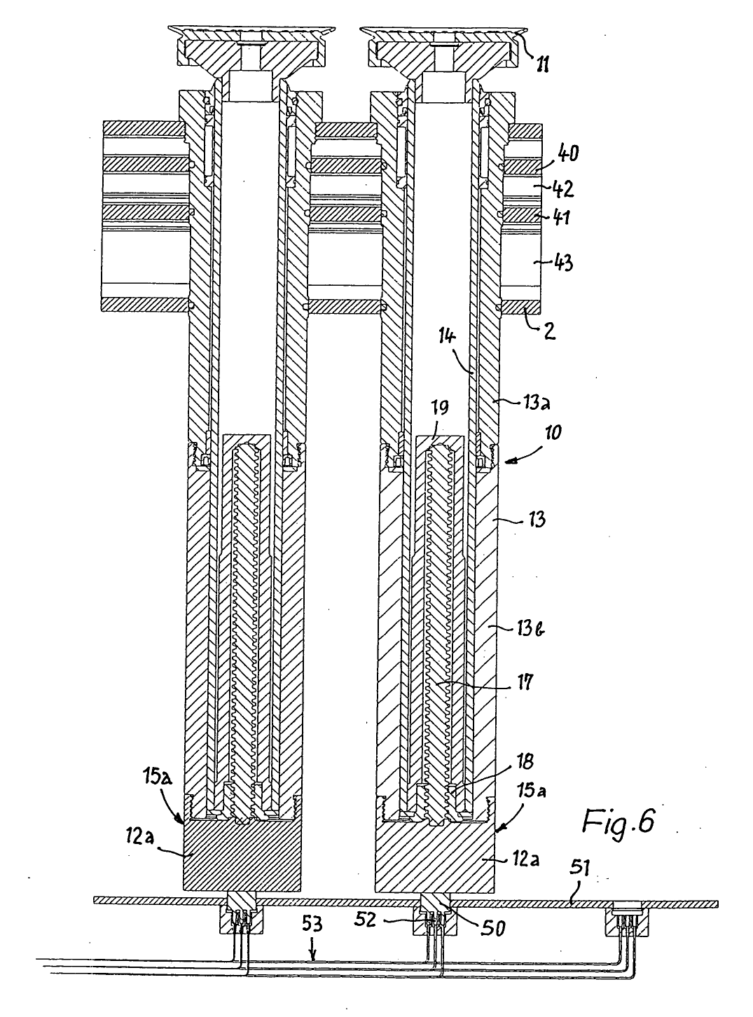

FIG. 6 shows a vertical section similar to FIG. 2 through two clamping elements of another embodiment, which are adjacent in the transverse direction (y-direction) of the clamping table,

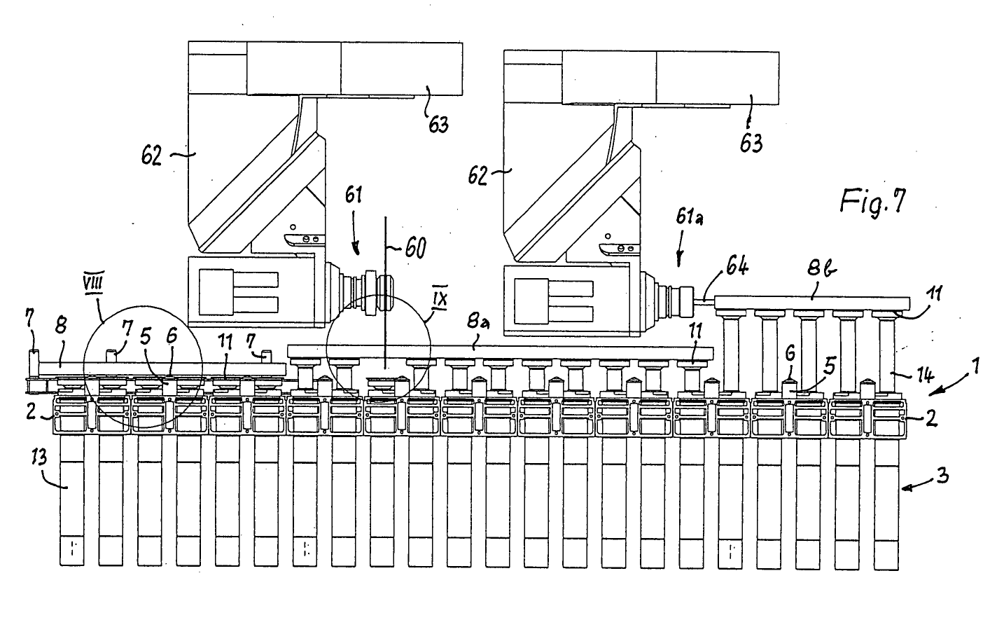

FIG. 7 shows a diagrammatic longitudinal section through the clamping table in FIG. 7 showing an associated extension arm carrying the machining head together with the machining assembly, in two different machining situations and different working positions of selected clamping elements,

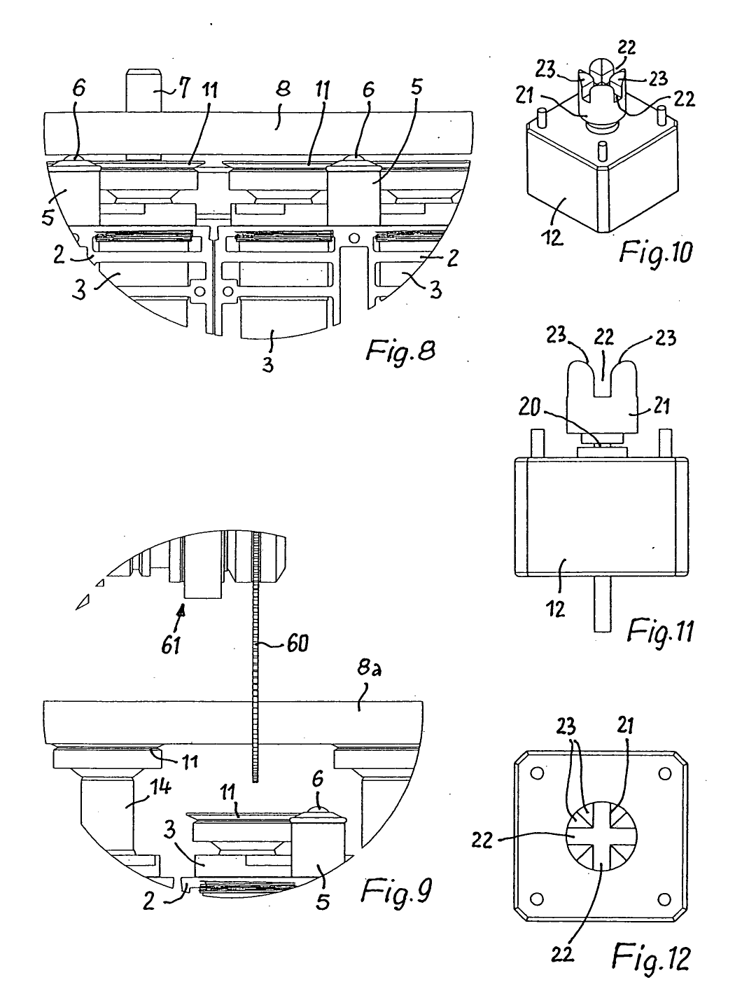

FIG. 8 shows the circled portion VIII in FIG. 7 on an enlarged scale,

FIG. 9 shows the circled portion IX in FIG. 7 on an enlarged scale,

FIG. 10 is a perspective view of a stepping motor together with coupling partner for a clamping element as shown in FIG. 2,

FIG. 11 shows a side view of the stepping motor together with its coupling partner in FIG. 10 on an enlarged scale, and

FIG. 12 shows a plan view of the stepping motor together with the coupling partner of FIGS. 10 and 11.

The clamping table 1 which can be seen in its substantial entirety in FIGS. 1 and 7 comprises a plurality of transversely extending (y-direction) transverse members 2, each of which holds a plurality of pairs of clamping elements 3 which are pushed in mutually juxtaposed relationship therethrough (see FIGS. 2 and 7). At their lower ends the clamping elements 3 are mounted to further transverse members 4 which extend parallel to the transverse members 2 and to which the clamping elements 3 are held in a manner which will be further described hereinafter (this has been omitted in the diagrammatic view in FIG. 7). The transverse members 2, 4 are fixed to a bed or frame (not shown in the drawings).

Provided between each four clamping elements 3 which are arranged in a square are respective supports 5 (see FIGS. 1 and 7) which each carry at their top end a support ball 6 which is rotatable in all directions. A workpiece to be machined is laid on the balls 6 in the rest or starting position of the clamping elements 3 and is displaced in the plane of the surface of the clamping table 1 before the clamping operation begins (FIG. 8). Abutments 7 serve for (right-angled) alignment of a workpiece 8 of plate or panel shape, on the clamping table 1 (FIGS. 7 and 8).

Each clamping element 3 of the embodiment shown in FIGS. 2 to 5 substantially comprises a telescopic tube unit 10, a suction plate 11 and a positioning drive 12 in the form of a stepping motor (FIG. 2). Each telescopic tube unit 10 comprises an outer stationary telescopic tube 13 and an inner, vertically movable telescopic tube 14. The outer telescopic tube 13 is fixed to the base portion 15 of the clamping element 3 and mounted in its interior is a shaft 16 which is extended in a spindle 17. A spindle nut 18 which is guided on the spindle 17 is fixed to the inner telescopic tube 14 so that a rotary movement of the spindle 17 with the shaft 16 results in a linear (upward) movement of the inner telescopic tube 14; a protection tube 19 which is closed at the top serves to keep the spindle transmission 17, 18 clean.

The stepping motor 12 is fixed in the transverse member 4 in the manner which can be seen from FIG. 2. Fixed on the drive output shaft 20 of the stepping motor 12 is a coupling partner 21 of a mechanical, positively locking plug coupling which has two transverse grooves 22 which extend in mutually perpendicular relationship; see also the enlarged views in FIGS. 4 and 5 illustrating the coupling in sections which are turned through 90° relative to each other. The edges of the transverse grooves 22 are provided by rounding with inclined insertion faces 23. A blade 24 of the other coupling partner 25 engages into one of the transverse grooves 22—in the assembled condition (FIG. 2)—, the coupling partner 25 being positively lockingly fixed to the shaft 16. In order to avoid stresses and constraints by virtue of an eccentricity between the drive output shaft 20 of the stepping motor 12 (and therewith the coupling partner 21) with respect to the shaft 16 of the spindle transmission 17, 18, the shaft 16 has a projection in the form of an inverted T-shape, the transverse web portion 26 of which is guided in a correspondingly C-shaped groove 27 in the coupling partner 25, the groove 27 extending perpendicularly to the longitudinal extent of the blade 24 (see FIGS. 4 and 5), so that the transverse web portion 26 can perform lateral compensating movements perpendicularly to the transverse extent of the blade 24. The electrical connections of the stepping motors 12 are not shown in FIG. 2.

The upper portion 13a of the outer (stationary) telescopic tube 13 is screwed to the lower portion 13b and carries a seal 30 in relation to the inner (movable) telescopic tube 14. A further seal 31 between the two telescopic tubes 13, 14 is provided at the upper end of the portion 13a of the telescopic tube. The means for holding the seal 31 is in the form of a ring 32 which holds an annular packing cuff 33 in the portion 13a of the telescopic tube. The cuff 33 comprises plastic material, of thin-wall gauge, with spaced fixing and sealing rings 34. The rings 34 form an annular space 35 between them, the annular cuff 33 and the portion 13a of the telescopic tube. The annular space 35 can be supplied with compressed air by way of an access bore 36 in the portion 13a of the telescopic tube in order to press the annular cuff against the inner telescopic tube 14 and in that way to arrest it when it is extended.

The transverse members 2 form air guide passages 42, 43 by means of parallel intermediate walls 40 and 41. For that purpose bores which are stepped in diameter, for receiving the clamping elements 3, are provided in the outside walls of the transverse members 2 and the walls 40, 41, which respectively seal off with O-ring seals 44 in relation to the telescopic tube portion 13a, which is correspondingly stepped in outside diameter, of the stationary telescopic tube 13. Fixing of the telescopic tube portion 13a and therewith the entire clamping element 3 is effected by screwing an enlarged-diameter part of the telescopic tube portion 13a into the upper outside wall of the transverse member 2 at 45 (FIG. 3). Compressed air is passed through the air guide passage 42 by way of the access bore 36 into the annular space 35 when, after extension of the inner telescopic tube 14, it is to be arrested with respect to the outer telescopic tube 13. A reduced pressure is applied to the air guide passage 43, the reduced pressure occurring through the inlet bore 48 at the intermediate space between the inner telescopic tube 14 and the outer telescopic tube portion. As long as the inner telescopic tube 14 is in its rest position shown in FIG. 2, the—continuously applied—reduced pressure cannot pass into the internal space in the inner telescopic tube 14 and take effect in the suction plate 11 through the central bore 47. If however the inner telescopic tube 14 is extended (upwardly), then the inlet bore 48 in the inner telescopic tube 14 moves past the seal 30 and is then in communication with the space between the inner telescopic tube 14 and the tube portion 13a of the outer telescopic tube 13 so that the reduced pressure is applied at the suction plate 11.

FIG. 6 shows another embodiment of the clamping element 3. In this clamping element the base portion 15a contains the positioning drive in the form of a stepping motor 12a, as an integral constituent part. It is connected directly to the spindle 17 which in other respects acts in the same manner as in the case of the first embodiment. A coaxial projection 50 on the stepping motor 12a provides both for mechanical centering of the clamping element in a bottom plate 51 (which is in place of the transverse member 4 of the first embodiment) and at the same time makes the electrical connection 52 to the feed line 53. In other respects the configuration of the clamping element corresponds to that of the first embodiment.

Reference will now be made to FIGS. 7 to 9 to describe operation of the clamping table according to the invention. When a workpiece of plate or panel form is laid on the clamping table, all clamping elements with their suction plates 11 are in the completely retracted (lowered) condition, as can best be seen from FIG. 8. The workpiece 8 rests on the balls 6 of the supports 5 and can be aligned in that way and in particular can be pushed against the abutments 7. Then, those clamping units 3 which by virtue of being extended would not impede later machining of the workpiece are activated. They are generally selected under program control; that is effected by actuating the associated stepping motors 12. The inner telescopic tubes 14 of the clamping elements 3 in question are thereby extended by means of the spindle transmission 17, 18 and uniformly lift the workpiece 8 off the supports 5. As soon as the inlet bore 48 passes the seal 30 in that case, reduced pressure is applied to the clamping plates 11 so that they clamp the workpiece fast. When the inner telescopic tubes 14 are in that condition of being only partly extended, for example the clamped workpiece 8a can be sawn (formatted) by means of a machining assembly having a circular saw blade 60, as is shown in the middle part of FIG. 7. The machining assembly 61 is held to a tool head 62—in the illustrated example a 5-axis tool head—which in turn is displaceable by means of an extension arm 63 in the longitudinal direction (x-direction) of the clamping table 1; details thereof have been omitted.

To the right of and beside the above-discussed arrangement, FIG. 7 shows lateral drilling or boring of a workpiece 8b by means of the same tool head 62, but with another machining assembly 61a having a drill 64. For that purpose the telescopic tubes 14 of the clamping elements 3 involved are completely extended.

The almost stepless alignment of the suction plates 11 of all clamping elements 3 of the clamping table with respect to the plane which is determined by the tool head, displaceable in the x- and y-directions, of a machine tool equipped with the clamping table, permits a kind of “calibration” to the effect that a zero position in respect of each clamping element is established in relation to the tool head 62 or a measuring bar or mandrel which is gripped in its tool receiving means (with the tool head being rotated through 180° with respect to its positions shown in FIG. 7), for example in such a way that the number of steps required for that purpose are ascertained and fed into the control system.

What is claimed is:

1. A clamping table for workpieces in a machine tool, comprising a plurality of mutually juxtaposed clamping elements which each have a respective telescopic tube unit with a top-end suction plate, wherein the concentric tubes of the telescopic tube unit are displaceable relative to each other by a positioning drive,
characterised in that the positioning drive is arranged coaxially with respect to the telescopic tube unit and is releasably coupled to the displaceable telescopic tube by means of a positively locking plug coupling.

2. A clamping table for workpieces in a machine tool, comprising a plurality of mutually juxtaposed clamping elements which each have a respective telescopic tube unit with a top-end suction plate, wherein the concentric tubes of the telescopic tube unit are displaceable relative to each other by a positioning drive,
characterised in that the positioning drive is arranged coaxially on the telescopic tube unit and is permanently coupled to the displaceable telescopic tube and is connected electrically to a power supply by means of a resealable plug connection.

3. A clamping table according to claim 2 characterised in that the plug connection also forms a mechanical centering means.

4. A clamping table according to claim 1 characterised in that the positioning drive is a stepping motor co-operating with a central spindle transmission in the telescopic unit.

5. A clamping table according to claim 1 characterised in that the telescopic units are each fixed with their suction plate and their coupling or electrical connecting partner in the transverse members which extend over the table by plugging in the outer telescopic tube therein and the plug coupling and the connection respectively is closed in the fixing position.

6. A clamping table according to claim 5 characterised in that positioning drives besides the respective coupling partner and electrical connecting partner are each also arranged in transverse members which extend parallel to the transverse members of the telescopic units.

7. A clamping table according to claim 5 characterised in that the transverse members of the telescopic units comprise hollow profile members having a plurality of parallel walls which form air guide passages and which are pierced by stepped bores for receiving the telescopic units, wherein annular seals arranged on same seal off in relation to the walls, axially displaced portions of the outer telescopic tube, in which there are provided radial access bores.

8. A clamping element for a clamping table according to claim 1 characterised in that the plug coupling comprises at least one central transverse groove in the one coupling partner and a blade engaging thereinto on the other coupling partner, wherein the blade sits on a cuff which is guided displaceably perpendicularly to the blade in a base portion of the other coupling partner.

9. A clamping element according to claim 8 characterised in that two transverse grooves are arranged in mutually perpendicularly relationship in a coupling partner.

10. A clamping element according to claim 8 characterised in that the edges of the transverse groove or grooves are provided with inclined insertion faces.

11. A clamping element for a clamping table according to claim 5 characterised in that the a suction air path passes from an access bore in the outer telescopic tube through the annular space between the tubes to an inlet bore in the inner telescopic tube, the internal space of which is in communication with the suction plate, wherein a seal in relation to the inner telescopic tube is arranged with axial displacement towards the coupling in the inside wall of the outer telescopic tube, which seal is between the access bore and the inlet bore only in the completely retracted condition of the inner telescopic tube and a subsequent short extension region.

12. A clamping table according claim 1 with clamping elements characterised by a workpiece feed plane which is defined by the surfaces of supports and which in the completely retracted condition of the inner telescopic tube is above the suction plate top sides but within the short extension region of the inner telescopic tube.

13. A clamping table according to claim 12 characterised in that the support surfaces are formed by balls rotatable in all directions.

14. A clamping element for a clamping table, in particular according to claim 1, characterised in that an annular cuff is fixed to the stationary (outer) telescopic tube of the telescopic tube unit near its end remote from the coupling, wherein the space between the cuff and the inside wall of the stationary telescopic tube can be acted upon by compressed air in order clampingly to arrest the moveable (inner) telescopic tube by pressing the cuff against the movable telescopic tube.

15. A clamping element according to claim 14 characterised in that the thin-wall cuff comprises plastic material integrally with spaced fixing and sealing rings.

16. A method of operating a clamping table according to claim 12 characterised in that the workpiece to be clamped is laid with lateral alignment on the supports, thereupon the clamping elements which are selected in programmed fashion are extended against the workpiece and lift the workpiece to beyond the short extension region so that reduced pressure passes though the suction air path to the suction plates forming the interrupted workpiece support surface and the workpiece is clamped fast, and finally those activated clamping elements are further extended into a working position.

17. A method of calibrating a machine tool having a clamping table according to claim 1 and a tool head which is displaceable under NC control over all clamping elements in a defined plane,
characterized in that each clamping element is moved towards the tool head or a measuring bar accommodated therein and the respective number of steps of the stepping motor which are required for that purpose for forming a workpiece support plane in parallel relationship with the defined plane is fed into the control system

18. A clamping table according to claim 2 characterised in that the telescopic units are each fixed with their suction plate and their coupling or electrical connecting partner in the transverse members which extend over the table by plugging in the outer telescopic tube therein and the plug coupling and the connection respectively is closed in the fixing position.

19. A clamping table according claim 2 with clamping elements characterised by a workpiece feed plane which is defined by the surfaces of supports and which in the completely retracted condition of the inner telescopic tube is above the suction plate top sides but within the short extension region of the inner telescopic tube.

20. A clamping element for a clamping table, in particular according to claim 2, characterised in that an annular cuff is fixed to the stationary (outer) telescopic tube of the telescopic tube unit near its end remote from the coupling, wherein the space between the cuff and the inside wall of the stationary telescopic tube-can be acted upon by compressed air in order clampingly to arrest the moveable (inner) telescopic tube by pressing the cuff against the movable telescopic tube.
